(19) United States
(12) Patent Application Publication
(10) Pub. No.: US 2025/0018814 A1
(43) Pub. Date: Jan. 16, 2025

(54) METHOD FOR OPERATING A CLIMATE CONDITIONING DEVICE OF A CHARGING STATION, A CONTROL DEVICE, CLIMATE CONDITIONING DEVICE AND CHARGING STATION

(71) Applicant: ads-tec Energy GmbH, Nürtingen (DE)

(72) Inventors: Simon BAREIß, Rudersberg (DE); Jörg RAMIN, Kirchheim (DE)

(21) Appl. No.: 18/767,204

(22) Filed: Jul. 9, 2024

(30) Foreign Application Priority Data
Jul. 13, 2023 (DE) 102023118659.0

(51) Int. Cl. B60L 53/62; B60L 58/12; B60L 58/24

(52) U.S. Cl. CPC B60L 53/62; B60L 58/12; B60L 58/24

(57) ABSTRACT

The invention relates to a method for operating a climate conditioning device of a charging station for an electrical device, wherein the climate conditioning device is configured to control the temperature of the charging station either actively in an active mode or passively in a passive mode, wherein, depending on a thermal state of the charging station and a state of charge parameter of an electrical device energy storage system of the electrical device connected to the charging station, a switch is made between the passive mode and the active mode.

The invention also relates to a control device, a climate conditioning device and a charging station for carrying out such a method, a climate conditioning device and a charging station having such a control device, and a charging station having such a climate conditioning device.

### CROSS REFERENCE TO RELATED APPLICATIONS

The present application claims the priority of German patent application No. 102023118659.0, filed on Jul. 13, 2023, which is expressly incorporated herein by reference in its entirety.

The invention relates to a method for operating a climate conditioning device of a charging station for an electrical device, in particular for an electric vehicle, a control device, a climate conditioning device and a charging station.

Advances in the development of battery storage systems enable a higher electrical capacity with, in particular, the same installation space for the battery storage system. This means that battery storage systems—also known as drive energy storage systems—with a higher electrical capacity can be installed in electric vehicles. Users of electric vehicles usually expect the battery storage system to be charged quickly so that they can continue driving in a timely manner and are thus not necessarily prepared to spend more time at the charging station due to a battery storage system with a larger electrical capacity. As a result, it is necessary to increase the charging capacity for charging the battery storage system. An increase in the charging capacity is accompanied in particular by an increase in the charging current and/or the charging voltage. The heat generated in the charging station, in particular by electronic modules, in particular by power electronics, is usually dissipated by a climate conditioning device in the charging station. It is known to operate such a climate conditioning device in an active mode, in particular using a thermodynamic cycle process, and in a passive mode, in particular using convection. Switching between active mode and passive mode is dependent on an internal temperature of the charging station and an ambient temperature surrounding the charging station, in particular an ambient air temperature. If the internal temperature or the ambient temperature rises and exceeds a preset threshold value, a switch is made from the passive mode to the active mode. Operating the climate conditioning device in the active mode requires a comparatively large amount of electrical energy, which results in corresponding costs. The electrical energy is required to operate a refrigerant compactor, in particular a compressor, of the thermodynamic cycle process. Due to the constant use of the refrigerant compactor a specified maintenance or replacement interval is reached comparatively quickly, meaning that the refrigerant compactor must be serviced or replaced. This results in maintenance and material costs, in particular for a new refrigerant compactor.

The object of the invention is thus to create a method for operating a climate conditioning device of a charging station for an electrical device, in particular for an electric vehicle, a control device, a climate conditioning device and a charging station, wherein the disadvantages mentioned are reduced, preferably do not occur.

The object is solved by providing the present technical teaching, in particular the teaching of the independent claims and the preferred embodiments disclosed in the dependent claims and the description.

The object is solved in particular by creating a method for operating a climate conditioning device of a charging station for an electrical device, in particular for an electric vehicle. The climate conditioning device is configured to control the temperature of the charging station either actively in an active mode or passively in a passive mode. Depending on a thermal state of the charging station and at least one state of charge parameter, which is particularly characteristic of a state of charge of an electrical device energy storage system of the electrical device to be charged, in particular a drive energy storage system of the electric vehicle connected to the charging station, a switch is made between the passive mode and the active mode.

In one embodiment, the at least one state of charge parameter is selected from the, in particular current, state of charge (abbreviated: SoC) of the device energy storage system itself, an, in particular current, maximum possible charging capacity of the device energy storage system, and an, in particular current, remaining state of charge (Remaining SoC) of the device energy storage system.

In particular, the remaining state of charge (Remaining SoC) is a differential value that is obtained by deducting from the full state of charge (Full SoC), in particular at 100%, the current state of charge (Current SoC). The full state of charge—displayed to the user as full, in particular 100%—may deviate from a technically maximum possible state of charge of energy storage cells of the device energy storage system. In particular, the full state of charge is the maximum state of charge to which a user can charge the device energy storage system during intended use if a charge limit set by the user is set to 100%. In particular, the full state of charge is a full state of charge (Full SoC) in accordance with ISO 15118-2 and/or ISO 15118-20. In particular, the full state of charge is transmitted from the electrical device to the charging station. If the full state of charge is not transmitted, i.e. is not known to the charging station in particular, a maximum state of charge of the device energy storage system for fast charging (Bulk SoC; boundary between a first charging phase with a constant charging current (CC: constant current) and a second charging phase with a constant charging voltage (CV: constant voltage) of the fast charging process, in particular in accordance with ISO 15118-2 and/or ISO 15118-20) is alternatively transmitted to the charging station. If the maximum state of charge of the device energy storage system for fast charging is not transmitted, and in particular is thus also unknown to the charging station, the charging station can use a predetermined substitute value, for example 90%. It is thus possible to calculate the remaining state of charge based on the full state of charge (Full SoC) of the device energy storage system or based on the maximum state of charge of the device energy storage system for fast charging (Bulk SoC) or based on a substitute value, for example 90%.

Switching between passive mode and active mode is advantageously dependent on the amount of residual energy still to be charged into the device energy storage system. In the case of device energy storage systems, the current maximum possible charging capacity depends, among other things, on the state of charge of the device energy storage system. The higher the state of charge, the lower the maximum possible charging capacity and the lower the amount of residual energy still to be charged into the device energy storage system and the associated heat generation. This charging capacity characteristic is advantageously taken into account in the method. In particular, a change to active mode based on the thermal state is avoided depending on the at least one state of charge parameter and the temperature of the charging station continues to be controlled in the passive mode. In particular, the at least one state of charge parameter is also selected from the current state of charge (abbreviated: SoC) of the device energy storage system itself, an, in particular current, maximum possible charging capacity of the device energy storage system, and an, in particular current, remaining state of charge (Remaining SoC) of the device energy storage system. This makes it possible to continue to control the temperature of the charging station in the passive mode, in particular to avoid a change to active mode, which is actually planned based on the thermal state, if the state of charge is relatively high, in particular if only a relatively small amount of energy is still to be charged into the device energy storage system, for example if the device energy storage system is charged to 90% and is to be charged to 100% or if the device energy storage system is charged to 40% and a user has set a charging limit of 50%, and/or if the possible charging capacity is relatively low. In the passive mode, the thermodynamic cycle process, in particular the refrigerant compactor, is advantageously not used, which reduces electrical energy consumption. In particular, the refrigerant compactor is used less frequently. This delays the specified maintenance interval or the specified replacement interval. This reduces maintenance and replacement costs in particular.

In particular, the amount of residual energy still to be charged into the device energy storage system depends on a technical charging limit of the device energy storage system or on a charging limit set by a user. In particular, the charging limit is transmitted from the electrical device to the charging station. In particular using the charging communication standard ISO 15118-2 and/or ISO 15118-20.

In the context of the present technical teaching, the term “controlling the temperature” refers in particular to cooling the charging station by means of a cooling medium, as well as recooling the cooling medium itself.

In the passive mode, the temperature of the cooling medium of the charging station is controlled in particular by means of convection, in particular by means of a first heat exchanger in contact with recooling cooling air—also known as a passive cooler. In particular, no thermodynamic cycle process, in particular no refrigerant compactor, is used in the passive mode. In particular, activation of the refrigerant compactor is not provided for in the passive mode, in particular it is prevented. In particular, the recooling cooling air flows through the first heat exchanger. In particular, the recooling cooling air is conveyed, in particular sucked, to the first heat exchanger by means of a fan device. In particular, the cooling medium of the charging station flows through the first heat exchanger, in particular in a flow-separated manner. In particular, the first heat exchanger transfers heat from the cooling medium to the recooling cooling air. In particular, the recooling cooling air is in particular sucked in ambient air of the charging station.

In the active mode, the temperature of the cooling medium in the charging station is controlled in particular by means of the thermodynamic cycle process. In particular, the refrigerant compactor, in particular a compressor, is used as part of the thermodynamic cycle process in the active mode. In particular, activation of the refrigerant compactor is enabled, in particular provided, in the active mode. In particular, a refrigerant flows through the thermodynamic cycle process. In particular, the refrigerant flows through a second heat exchanger—also known as an active cooler. In particular, the cooling medium from the charging station flows through the second heat exchanger, in particular in a flow-separated manner. In particular, the second heat exchanger transfers heat from the cooling medium to the refrigerant.

It is possible for the temperature of the cooling medium of the charging station to be controlled in the active mode by means of the thermodynamic cycle process—mediated via the active cooler—and additionally by means of convection, in particular by means of the first heat exchanger (passive cooler) in contact with the recooling cooling air. In particular, a first heat component of the heat of the cooling medium is transferred to the recooling cooling air by means of the passive cooler designed as a first heat exchanger. In particular, a second heat component of the heat of the cooling medium is transferred to the refrigerant by means of the active cooler designed as a second heat exchanger.

According to a further development of the invention, it is provided that the thermal state of the charging station is determined by at least one state parameter selected from a group consisting of: An internal temperature of the charging station, an energy storage system temperature of an electrical energy storage system of the charging station, a cooling medium temperature of the cooling medium of the climate conditioning device, a heat loss capacity value which is characteristic of a heat loss of electrical components of the charging station, an ambient temperature, in particular ambient air temperature, a fan speed of the fan device of the charging station, a condensation temperature, a condensation pressure of the refrigerant, and a combination of at least two of these state parameters. Advantageously, the thermal state of the charging station can be determined particularly accurately.

In particular, the internal temperature of the charging station is an internal housing temperature of the charging station. In particular, the electrical components of the charging station are the power electronics of the charging station. In particular, the ambient temperature, in particular the ambient air temperature, is a temperature of the ambient air outside and in the vicinity of the charging station. In particular, the ambient temperature, in particular the ambient air temperature, is a temperature that the air sucked in by the charging station—referred to as recooling cooling air—has for temperature control. In particular, the fan speed is a fan speed of the fan device assigned to the first heat exchanger.

In one embodiment, the heat loss capacity value is a current heat loss capacity value. In another embodiment, the heat loss capacity value is an expected heat loss capacity value obtained, in particular calculated, by means of a calculation model, in particular a thermal model. Advantageously, the expected heat loss capacity value to be expected during the entire charging process of the device energy storage system can already be estimated, in particular calculated, at the start of the charging process using the at least one state of charge parameter of the device energy storage system, which serves as the input value for the calculation model.

In one embodiment, the cooling medium is a water-based medium, in particular a water-glycol mixture.

According to a further development of the invention, it is provided that the passive mode is activated if a cooling capacity value comparison, in particular a capacity test, in particular a cooling capacity test, shows that a maximum passive cooling capacity value, which is characteristic of a, in particular current, maximum possible passive cooling capacity of the climate conditioning device, is greater than a sum of the heat loss capacity value and an offset capacity value. The offset capacity value is determined as a function of the state of charge parameter of the device energy storage system of the electrical device connected to the charging station, in particular the electric vehicle.

In one embodiment, the maximum passive cooling capacity value is dependent on the cooling medium temperature, in particular within a heat storage device of the charging station in which the cooling medium is stored, on the ambient temperature, in particular the ambient air temperature, and on the fan speed, in particular the maximum fan speed of the fan device.

In particular, the maximum passive cooling capacity value is a positive value, in particular a value with a positive sign. In particular, the heat loss capacity value is a positive value, in particular a value with a positive sign. In particular, the offset capacity value is a positive or negative value, in particular a value with a positive or negative sign. Whether the offset capacity value is included in the cooling capacity value comparison as a positive or negative value depends in particular on a positive contribution and a negative contribution, by means of which the offset capacity value is determined, in particular calculated. The offset capacity value takes into account as a positive contribution in particular a heat loss capacity parameter. The heat loss capacity parameter contains in particular one or a plurality of partial heat loss capacity values which are not included in the heat loss capacity value, such as a heat loss capacity value from a display device of the charging station. In particular, the offset capacity value takes into account as a negative contribution a state of charge parameter correction value which is determined from the at least one state of charge parameter. The state of charge parameter correction value is in particular a heat loss capacity correction value, in particular a type of passive cooling capacity value buffer, which still enables the passive mode although the system should be switched to the active mode. For example, a situation is conceivable in which the maximum passive cooling capacity value is lower than the heat loss capacity value. The climate conditioning device is then no longer able to create a thermal balance in the passively temperature-controlled charging station. The charging station heats up continuously, in particular over a longer period of time. The climate conditioning device should now switch to active mode, in particular control the temperature of the charging station in the active mode. However, as fast charging processes do not usually take very long, it is possible to control the temperature of the charging station in the passive mode even if the climate conditioning device is no longer able to establish thermal equilibrium, since the thermal imbalance is only of relatively short duration. A certain amount of heating of the charging station is thus tolerated, since it can be assumed that the heat loss capacity value decreases after the fast charging process is completed and the climate conditioning device is then once again able to sufficiently control the temperature in the charging station passively. This tolerance, in particular the tolerated thermal imbalance over a certain period of time, is taken into account in the method by means of the negative contribution in the offset capacity value.

According to a further development of the invention, it is provided that the offset capacity value is determined by means of an offset characteristic curve. The offset characteristic curve has the at least one state of charge parameter as at least one input value and the offset capacity value as the output value. Advantageously, this makes it particularly easy to determine the offset capacity value.

In one embodiment, the offset characteristic curve has as the at least one input value the in particular current state of charge and the in particular current maximum possible charging capacity of the device energy storage system. In particular, the offset characteristic curve is a multi-dimensional characteristic curve. In particular, the offset characteristic curve has two input dimensions and one output dimension.

In one embodiment, the offset characteristic curve has the heat loss capacity parameter as a further input value of the at least one input value.

According to a further development of the invention, it is provided that before the offset capacity value is determined, it is determined whether an energy-saving mode of the charging station is activated. When the energy-saving mode is activated, an eco-offset characteristic curve is used as the offset characteristic curve to determine the offset capacity value.

In particular, a standard offset characteristic curve is used as the offset characteristic curve when the energy-saving mode is deactivated. In particular, exactly two offset characteristic curves are stored in the charging station, namely the standard offset characteristic curve and the eco-offset characteristic curve.

In particular, the standard offset characteristic curve and the eco-offset characteristic curve differ in that, for the same state of charge (SoC) or the same remaining state of charge (Remaining SoC), using the eco-offset characteristic curve results in a lower absolute offset capacity value—seen with a sign—than using the standard offset characteristic curve. Illustrated by an example: When using the standard offset characteristic curve, an initial offset capacity value is determined for any state of charge (SoC). When using the eco-offset characteristic curve, a second offset capacity value is determined for the same state of charge (SoC). The first offset capacity value is greater in absolute terms—seen with a sign—than the second offset capacity value.

The advantage of using the eco-offset characteristic curve is that it is possible to control the temperature of the charging station longer in the passive mode than when using the standard offset characteristic curve. In particular, greater heating of the charging station is tolerated when using the eco-offset characteristic curve than when using the standard offset characteristic curve.

According to a further development of the invention, it is provided that a blocking criterion is checked, wherein the passive mode is not activated or the passive mode is exited if the blocking criterion is met. This is an advantageous way of ensuring that the passive mode is only used, and in particular only permitted, when predetermined parameters are met.

In particular, the blocking criterion is checked before the cooling capacity value comparison. If the blocking criterion is met, the active mode is activated or the active mode is maintained, in particular not exited. In particular, the cooling capacity value comparison is then blocked, in particular not carried out.

According to a further development of the invention, it is provided that, as the blocking criterion, it is checked whether at least one of the following conditions is met: a) an energy storage system temperature of the electrical energy storage system of the charging station is greater than a predetermined maximum energy storage system temperature; b) the ambient temperature is greater than a predetermined maximum ambient temperature; and c) the cooling medium temperature is greater than a predetermined maximum cooling medium temperature.

According to a further development of the invention, it is provided that the method is carried out repeatedly. The advantage of this is that the charging station is continuously monitored so that it is possible to switch between the passive mode and the active mode as quickly as possible.

In particular, the method is carried out cyclically, in particular after a predetermined period of time. In particular, the method is carried out at a frequency of 1 Hz to 10 Hz, in particular 5 Hz.

The object is also solved by creating a control device for a climate conditioning device for a charging station for an electrical device, in particular an electric vehicle. The control device is controllably operatively connectable to the climate conditioning device, in particular controllably operatively connected, and is configured to carry out a method according to the invention or a method according to one or a plurality of the previously described embodiments. The control device is operatively connectable, in particular operatively connected, to a device interface and is configured to determine the at least one state of charge parameter of an electrical device energy storage system of the electrical device connected to the device interface. In particular, the control device is operatively connectable, in particular operatively connected, to an electric vehicle interface and is configured to determine the at least one state of charge parameter of an electric drive energy storage system of the electric vehicle connected to the electric vehicle interface. In connection with the control device, the advantages already explained in connection with the method apply in particular.

In one embodiment, the device interface, in particular the electric vehicle interface, is a combined charging system interface (Combined Charging System; abbreviated: CCS). In particular, the electric vehicle interface is a CCS type 2 interface.

The object is also solved by creating a climate conditioning device for a charging station for an electrical device, in particular for an electric vehicle. The climate conditioning device is arranged for carrying out a method according to the invention or a method according to one or a plurality of the embodiments described above. Alternatively or additionally, it is provided that the climate conditioning device has a control device according to the invention or a control device according to one or a plurality of the embodiments described above. In connection with the climate conditioning device, the advantages already explained in connection with the method apply in particular.

In one embodiment, the climate conditioning device has a compression refrigeration machine with a closed refrigerant circuit which—in the specified order in the direction of flow of the refrigerant—has the following refrigeration components: the refrigerant compactor, a condenser, a throttle device or a relief valve, and an evaporator. In particular, the climate conditioning device is configured to carry out the thermodynamic cycle process.

In one embodiment, the climate conditioning device is configured to cool a cooling air flow—different from a recooling cooling air flow of the recooling cooling air—provided for cooling the charging station. In another embodiment, the climate conditioning device is configured to cool a cooling medium circuit provided for cooling the charging station, in particular a cooling water circuit, in particular the water/glycol mixture. In yet another embodiment, the climate conditioning device is configured to cool both a cooling air flow provided for cooling the charging station and a cooling medium circuit, in particular a cooling water circuit, also provided for cooling the charging station. In particular, it is possible for the cooling air flow to be used to cool an electrical energy storage system of the charging station, while the cooling media circuit is used to cool the power electronics of the charging station. In a further embodiment, it is provided in particular that the cooling air flow used to cool the electrical energy storage system is cooled directly by the cooling media circuit, wherein the cooling media circuit also cools the power electronics of the charging station directly, and wherein the cooling media circuit itself is recooled by the climate conditioning device. In particular, it is possible for the climate conditioning device to be used exclusively for recooling the cooling medium circuit, wherein the various components of the charging station are cooled directly or indirectly by the cooling medium circuit.

In one embodiment, the climate conditioning device has the first heat exchanger (passive cooler) and the second heat exchanger (active cooler). In particular, the same cooling medium, in particular the water-glycol mixture, flows through the first heat exchanger and the second heat exchanger. In particular, the climate conditioning device has a third heat exchanger as the condenser.

In one embodiment, the cooling medium in the cooling medium circuit first flows from the heat storage device through a cooling medium feed device and then through a changeover valve, which divides the cooling medium circuit into a basic path and an extended path in a switchable manner. In the basic path, the cooling medium flows through the second heat exchanger (active cooler) in a first functional position of the changeover valve starting from the changeover valve, in particular optionally or in another configuration necessarily through a fourth heat exchanger, which is intended for cooling the cooling air flow assigned to the electrical energy storage system, and returns to the heat storage device. In the extended path, the cooling medium flows through the first heat exchanger (passive cooler), the second heat exchanger (active cooler), in particular optionally or in another configuration necessarily through the fourth heat exchanger, in a second functional position of the changeover valve starting from the changeover valve, and returns to the heat storage device. In particular, the extended path thus contains the basic path.

In one embodiment, the active mode can be operated with either the basic path or the extended path, and the passive mode with the extended path. In particular, the active mode can be operated with both functional positions of the changeover valve: If the changeover valve is switched to the base path in the active mode, the cooling medium is actively cooled, mediated via the second heat exchanger (active cooler) of the thermodynamic cycle process whose compressor is activated. If the changeover valve is switched to the extended path in the active mode, the cooling medium is first passively cooled by means of the first heat exchanger (passive cooler) and then—as in the active mode when the basic path is activated—actively cooled, mediated via the second heat exchanger (active cooler) of the thermodynamic cycle process whose compressor is activated. If the changeover valve is switched to the extended path in the passive mode, the cooling medium is passively cooled by means of the first heat exchanger (passive cooler). The cooling medium then flows through the second heat exchanger (active cooler) of the thermodynamic cycle process, but its compressor is deactivated so that no cooling takes place here.

In particular, the changeover valve is switched to the base path in relatively hot weather, in particular when the ambient air is relatively hot. This advantageously prevents heat transfer from the ambient air to the cooling medium by means of the first heat exchanger (passive cooler).

In one embodiment, the first heat exchanger (passive cooler) has a first heat sink and the third heat exchanger (condenser) has a different, second heat sink. In particular, the first heat sink and the second heat sink are arranged adjacent to each other, in particular one behind the other in the direction of flow of the recooling cooling air. Advantageously, the same fan device can be used for the first heat sink and the second heat sink.

The object is also solved by creating a charging station for an electrical device, in particular for an electric vehicle. The charging station is arranged for carrying out a method according to the invention or a method according to one or a plurality of the previously described embodiments. Alternatively or additionally, it is provided that the charging station has a control device according to the invention or a control device according to one or a plurality of the embodiments described above. Alternatively or additionally, it is provided that the charging station has a climate conditioning device according to the invention or a climate conditioning device according to one or a plurality of the embodiments described above. In connection with the charging station, the advantages already explained in connection with the method apply in particular.

In electrical engineering, a charging station is any device or electrical system, in particular stationary or mobile, which is used to supply energy to mobile battery-powered devices, machines or motor vehicles by simply plugging them in without necessarily having to remove the energy storage system—such as the traction battery of an electric car. Charging stations for electric cars are sometimes also referred to as “electric charging stations” and can include a plurality of charging points. High performance charging systems or high power charging system (HPC systems) such as the combined charging system (CCS), which is widespread in Europe, are particularly well known. With generic direct current charging, direct current from the charging station is fed directly into the vehicle's battery and provided by a powerful rectifier, preferably of the charging station, from the power grid or by large buffer accumulators at solar charging stations, for example. There is a battery management system in the vehicle that communicates directly or indirectly with the charging station to adjust the current and voltage or to terminate the process when a predetermined capacity limit is reached. Power electronics are usually located in the charging station. Since the direct current connections of the charging station are connected directly to the corresponding connections of the traction battery—without a detour through an AC/DC converter of the vehicle—high charging currents can be transmitted with low losses, which enables short charging times.

In one embodiment, the charging station is designed as a charging column. In particular, the charging station has at least one charging point, in particular exactly one charging point or exactly two charging points.

In particular, the charging station is designed as a fast charging station. In one embodiment, the charging station has an energy storage system, thus is in particular designed as a battery-supported charging station, in particular as a battery-supported fast charging station.

In one embodiment, the charging station has at least one sensor selected from a group consisting of: An internal temperature sensor, an ambient air temperature sensor, an energy storage system temperature sensor of the energy storage system of the charging station and a heat storage device temperature sensor of the heat storage device of the charging station. In one embodiment, the charging station has a plurality of one of the selected sensors, in particular twice, in particular for redundancy reasons.

In one embodiment, the temperature of the charging station is controlled in the active mode in the event of a sensor failure—provided this sensor is not present a second time or the second sensor is not functional. In particular, an error message is transmitted via a wired or wireless data connection, in particular to a control center.

It is possible that the changeover valve, which switches the cooling circuit of the climate conditioning device between the first functional position (basic path) and the second functional position (extended path), no longer functions. In this case, the cooling circuit can no longer be switched between the extended path and the basic path. If the temperature of the charging station was controlled in the active mode with activated basic path or extended path directly before the valve defect, an error message can be transmitted to the control center. A warning for the user is not necessarily displayed, since the temperature of the charging station is controlled in the active mode anyway. However, if the temperature of the charging station was controlled in the active mode with the basic path activated directly before the valve defect, it is no longer possible to switch to the passive mode—which requires the extended path. If the temperature of the charging station was controlled in the passive mode with the extended path activated directly before the valve defect, an error message can also be transmitted to the control center. A warning for the user is not necessarily displayed here either, since it is possible to switch from the passive mode to the active mode by activating the compressor of the thermodynamic cycle process.

A defective changeover valve that has remained in the first functional position (basic path) thus has the effect that the passive mode can no longer be activated. The disadvantage of this is higher operating costs, as the compressor is operated in the active mode. A defective changeover valve that has remained in the second functional position (extended path) has the effect that a heat transfer from the ambient air to the cooling medium via the first heat exchanger (passive cooler) can no longer be avoided in hot weather. This also has the disadvantage of higher operating costs, as the heat introduced into the cooling medium by the first heat exchanger (passive cooler) has to be extracted again from the thermodynamic cycle process.

In one embodiment, the charging station is switched between the passive mode and the active mode remotely, in particular by means of a wired or wireless data connection from the control center.

### BRIEF DESCRIPTION OF THE DRAWINGS

The invention is explained in more detail below with reference to the drawing. The Figures show:

FIG. 1 shows a schematic representation of a first embodiment example of a charging station,

FIG. 2 shows a schematic process diagram of a first embodiment example of a method for operating a climate conditioning device of the charging station according to FIG. 1, and

FIG. 3 shows a schematic process diagram of a second embodiment example of a method for operating the climate conditioning device of the charging station according to FIG. 1.

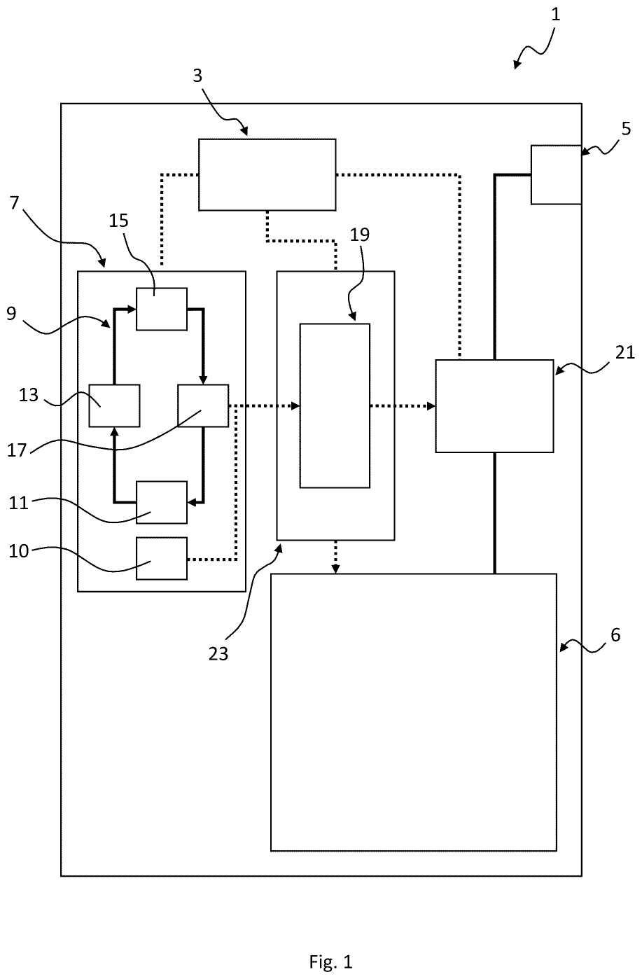

FIG. 1 shows a schematic representation of a first embodiment of a charging station 1, in particular for electric vehicles, with an embodiment example of a control device 3.

The charging station 1 has at least one charging point in the form of a device interface 5, wherein one electric vehicle, for example, can be charged at each charging point. In addition, the charging station 1 has an electrical energy storage system 6 for the intermediate storage of electrical energy for charging electric vehicles in particular. The charging station 1 can be connected to a power grid, wherein the electrical energy storage system 6 is regularly charged from the power grid; however, it can also be designed as a mobile charging station 1 which can be operated independently of a power grid, wherein the electrical energy storage system 6 is only recharged sporadically, in particular when required.

The charging station 1 also has a climate conditioning device 7, which is designed here as a compression refrigeration machine for carrying out a thermodynamic cycle process. It has a closed refrigerant circuit 9, which has the following refrigeration components—in the specified order in the direction of flow of the refrigerant: a refrigerant compactor 11, a condenser 13, a throttling device 15 and an evaporator 17. The climate conditioning device 7 also has a passive cooler 10 designed as a first heat exchanger, the temperature of which is controlled by means of convection, in particular by means of recooling cooling air sucked in from the ambient air. In particular, the evaporator 17 is a second heat exchanger. In particular, the condenser 13 is a third heat exchanger.

In particular, the climate conditioning device 7 is configured to recool a cooling medium circuit 19 provided for cooling the charging station 1, in particular a cooling water circuit. This can take place by means of the first heat exchanger (passive cooler 10). Alternatively or additionally, this can take place by means of the third heat exchanger (evaporator 17 as an active cooler). The cooling media circuit 19 in turn preferably cools power electronics 21 of the charging station 1 directly and also a cooling air flow, wherein the electrical energy storage system 6 of the charging station 1 is cooled by means of the cooling air flow.

The cooling media circuit 19 is in particular part of a cooling device which, in addition to the cooling media circuit 19, can for example also comprise fans, in particular a fan for generating the cooling air flow for cooling the electrical energy storage system 6 and/or a fan for generating the recooling cooling air flow for cooling the passive cooler 10.

The climate conditioning device 7 and the control device 3 are configured in particular to carry out a method described in more detail below.

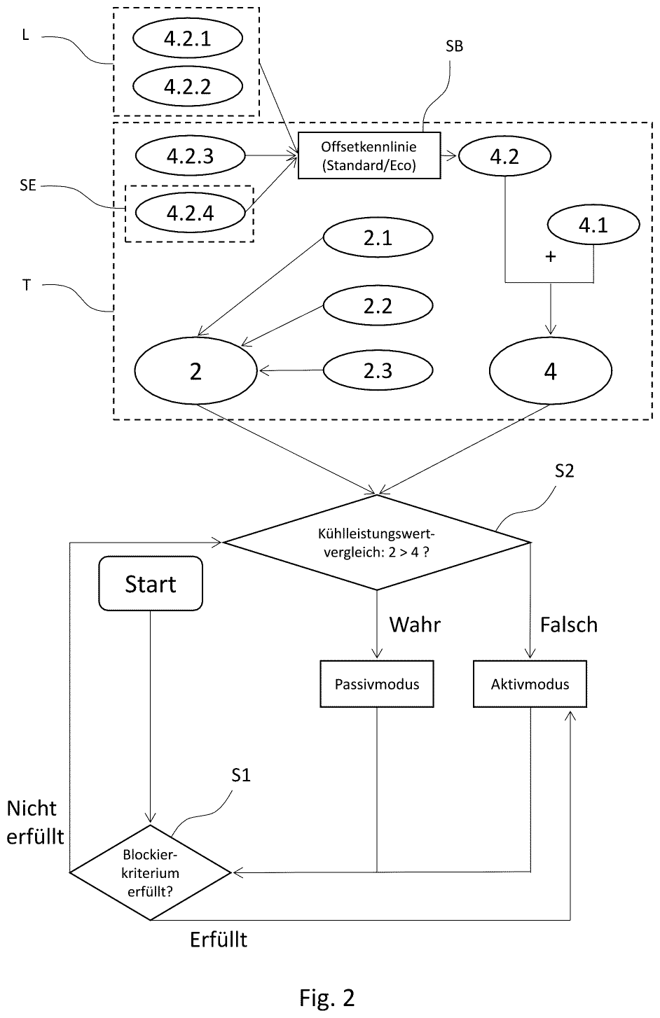

FIG. 2 shows a schematic process diagram of a first embodiment of a method for operating the climate conditioning device 7 of the charging station 1 according to FIG. 1.

The climate conditioning device 7 is configured to control the temperature of the charging station 1 either actively in an active mode or passively in a passive mode. Depending on a thermal state T of the charging station 1 and at least one state of charge parameter L, which is particularly characteristic of a state of charge 4.2.1 of an electric drive energy storage system of an electric vehicle connected to the charging station 1, a switch is made between the passive mode and the active mode.

According to the first embodiment example, the method is as follows: In a first step S1, it is provided that a blocking criterion is checked, wherein the passive mode is not activated or the passive mode is exited if the blocking criterion is met. In particular, the blocking criterion is checked at the beginning and during the method. If the blocking criterion is met, the active mode is activated or the active mode is maintained, in particular not exited. In particular, a cooling capacity value comparison is blocked, in particular not carried out.

If the blocking criterion is not met, the cooling capacity value comparison is carried out in a second step S2. It is provided that the passive mode is activated if the cooling capacity value comparison carried out, in particular a capacity test, in particular a cooling capacity test, shows that a maximum passive cooling capacity value 2, which is characteristic of a, in particular current, maximum possible passive cooling capacity of the climate conditioning device 7, is greater than a sum 4 of a heat loss capacity value 4.1 and an offset capacity value 4.2. The offset capacity value 4.2 is determined as a function of the at least one state of charge parameter L of the drive energy storage system of the electric vehicle connected to the charging station 1 and a heat loss capacity parameter 4.2.3.

In this embodiment, it is envisaged that the method is carried out repeatedly. In particular, the method is carried out cyclically, in particular after a predetermined period of time. In particular, the method is carried out at a frequency of 1 Hz to 10 Hz, in particular 5 Hz.

The input variables required for the method are as follows:

In this embodiment example, the thermal state T of the charging station 1 is determined by the following state parameters: A cooling medium temperature 2.1 of a cooling medium of the climate conditioning device 7, a heat loss capacity value 4.1, which is characteristic of a heat loss of electrical components, in particular of the power electronics 21, of the charging station 1, an ambient temperature 2.2, in particular ambient air temperature, and a fan speed 2.3 of a fan device of the charging station 1.

In another embodiment example, it is provided that the thermal state T of the charging station 1 is additionally determined by at least one further state parameter selected from a group consisting of: An internal temperature of the charging station 1, an energy storage system temperature of an electrical energy storage system 6 of the charging station 1, a condensation temperature, a condensation pressure of the refrigerant, and a combination of at least two of these state parameters.

In this embodiment example, the at least one state of charge parameter L is selected, in particular calculated, from the, in particular current, state of charge 4.2.1 (abbreviated: SoC) of the device energy storage system itself and a, in particular current, maximum possible charging capacity 4.2.2 of the device energy storage system.

In another embodiment example not shown, it is provided that the at least one state of charge parameter L is additionally an, in particular current, remaining state of charge parameter (Remaining SoC) of the device energy storage system.

In this embodiment example, it is provided that, as the blocking criterion, it is checked whether at least one of the following conditions is met: a) an energy storage system temperature of the electrical energy storage system 6 of the charging station 1 is greater than a predetermined maximum energy storage system temperature; b) the ambient temperature 2.2 is greater than a predetermined maximum ambient temperature; and c) the cooling medium temperature 2.1 is greater than a predetermined maximum cooling medium temperature.

In particular, the heat loss capacity parameter 4.2.3 contains one or more partial heat loss capacity values that are not included in the heat loss capacity value 4.1, such as a heat loss capacity value from a display device of the charging station 1.

In this embodiment example, it is provided that the offset capacity value 4.2 is determined by means of an offset characteristic curve in a determination step SB. The offset characteristic curve has the state of charge parameter L and the heat loss capacity parameter 4.2.3 as at least one input value, and the offset capacity value 4.2 as the output value.

In this embodiment example, it is provided that before the offset capacity value 4.2 is determined, it is determined in a determination step SE whether an energy-saving mode 4.2.4 of the charging station 1 is activated. If the energy-saving mode 4.2.4 is activated, an eco-offset characteristic curve is used as the offset characteristic curve to determine the offset capacity value 4.2, otherwise a standard offset characteristic curve is used.

In this embodiment example, it is provided that the input variables are queried repeatedly. In particular, the input variables are queried cyclically, in particular after a predetermined period of time. In particular, the input variables are scanned at a frequency of 1 Hz to 10 Hz, in particular 5 Hz.

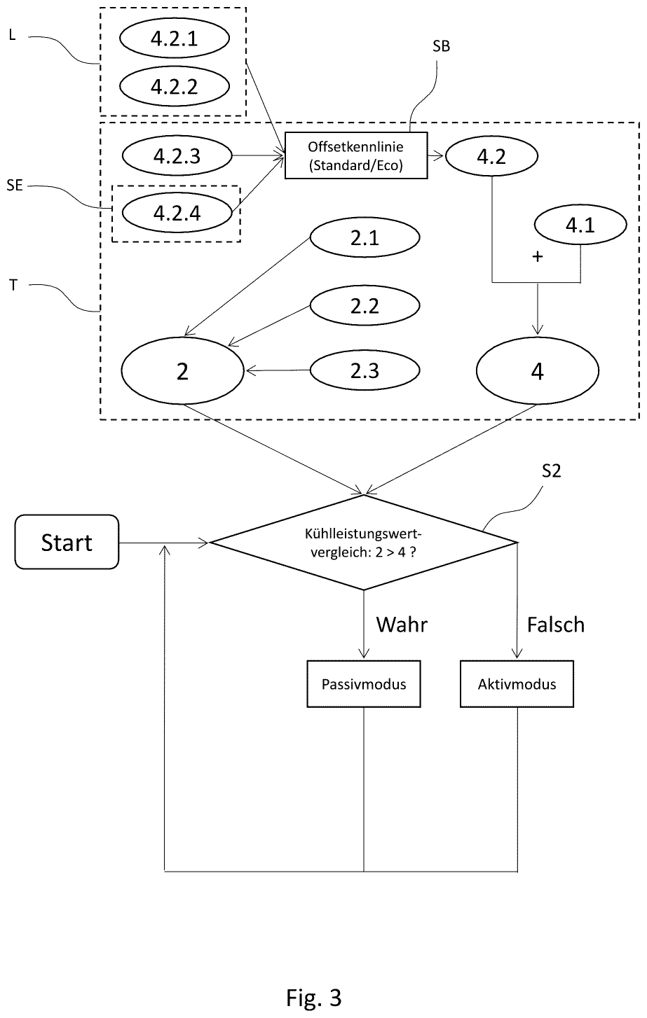

FIG. 3 shows a schematic process diagram of a second embodiment example of a method for operating the climate conditioning device 7 of the charging station 1 according to FIG. 1.

Identical and functionally identical elements are provided with the same reference numbers in all FIGS., so that reference is made to the previous description in each case.

The method according to FIG. 3 differs from the method according to FIG. 2 in that the first step S1, namely the check for the blocking criterion, is omitted, in particular is not carried out.

In this embodiment example, the second step S2, namely the cooling capacity value comparison, is carried out at the start of the method. As in the method in FIG. 2, it is provided that the passive mode is activated if the cooling capacity value comparison carried out, in particular the capacity test, in particular the cooling capacity test, shows that the maximum passive cooling capacity value 2, which is characteristic of the, in particular current, maximum possible passive cooling capacity of the climate conditioning device 7, is greater than the sum 4 of the heat loss capacity value 4.1 and the offset capacity value 4.2. The offset capacity value 4.2 is determined as a function of the state of charge parameter L of the drive energy storage system of the electric vehicle connected to the charging station 1 and the heat loss capacity parameter 4.2.3.

In particular, the method is also carried out repeatedly in this embodiment. In particular, the method is carried out cyclically, in particular after a predetermined period of time. In particular, the method is carried out at a frequency of 1 Hz to 10 Hz, in particular 5 Hz.

In particular, the input variables are also queried repeatedly in this embodiment example. In particular, the input variables are queried cyclically, in particular after a predetermined period of time. In particular, the input variables are scanned at a frequency of 1 Hz to 10 Hz, in particular 5 Hz.

1. A method for operating a climate conditioning device of a charging station for an electrical device, wherein the climate conditioning device is configured to control the temperature of the charging station either actively in an active mode or passively in a passive mode, wherein, depending on a thermal state of the charging station and at least one state of charge parameter of an electrical device energy storage system of the electrical device connected to the charging station, a switch is made between the passive mode and the active mode.

2. The method according to claim 1 wherein the thermal state of the charging station is determined by at least one state parameter selected from a group consisting of: An internal temperature of the charging station, an energy storage system temperature of an electrical energy storage system of the charging station, a cooling medium temperature of a cooling medium of the climate conditioning device, a heat loss capacity value which is characteristic of a heat loss of electrical components of the charging station, an ambient temperature, in particular ambient air temperature, a fan speed of the fan device of the charging station, a condensation temperature, a condensation pressure of the refrigerant, and a combination of at least two of these state parameters.

3. The method according to claim 1, wherein
the passive mode is activated if a cooling capacity value comparison shows that a maximum passive cooling capacity value, which is characteristic of a maximum possible passive cooling capacity of the climate conditioning device, is greater than a sum of the heat loss capacity value and an offset capacity value, wherein
the offset capacity value is determined as a function of the at least one charge state parameter of the device energy storage system of the electrical device connected to the charging station.

4. The method according to claim 1, wherein
the offset capacity value is determined by means of an offset characteristic curve, wherein
the offset characteristic curve has the at least one state of charge parameter as at least one input value and the offset capacity value as the output value.

5. The method according to claim 1, wherein
before the offset capacity value is determined, it is determined whether an energy-saving mode of the charging station is activated, wherein
when the energy-saving mode is activated, an eco-offset characteristic curve is used as the offset characteristic curve to determine the offset capacity value.

6. The method according to claim 1, wherein a blocking criterion is checked, wherein the passive mode is not activated or the passive mode is exited if the blocking criterion is met.

7. The method according to claim 6, wherein as the blocking criterion, it is checked whether at least one of the following conditions is met:
a) an energy storage system temperature of the electrical energy storage system of the charging station is greater than a predetermined maximum energy storage system temperature;
b) the ambient temperature is greater than a predetermined maximum ambient temperature; and
c) the cooling medium temperature is greater than a predetermined maximum cooling medium temperature.

8. The method according to claim 1, wherein the method is carried out repeatedly.

9. A control device for a climate conditioning device of a charging station for an electrical device, wherein
the control device is controllably operatively connectable to the climate conditioning device and is arranged to carry out a method according to one of the preceding claims, wherein
the control device is operatively connectable to a device interface and is configured to determine the at least one state of charge parameter of an electrical device energy storage system of the electrical device connected to the device interface.

10. A climate conditioning device for a charging station for an electrical device, wherein
the climate conditioning device is configured to carry out a method according to claim 1, and/or
the climate conditioning device has a control device.

11. A charging station for an electrical device, wherein
the charging station is configured to be operated with a method according to claim 1, and/or
the charging station has a control device, and/or
a climate conditioning device.
